(19) United States
(12) Patent Application Publication
(10) Pub. No.: US 2024/0415120 A1
(43) Pub. Date: Dec. 19, 2024

(54) BINARY BIOHERBICIDE COMPRISING PELARGONIC ACID

(71) Applicant: YPF TECNOLOGÍA S.A., Ciudad Autónoma de Buenos Aires (AR)

(72) Inventors: Jimena HERRERA, Berisso (AR); Marcos YANNICARI, Tres Arroyos (AR); Marcos COUSTET, Berisso (AR); Aline SCHNEIDER TEIXEIRA, Berisso (AR); Sebastián REINOSO, Berisso (AR); Daniela Betiana MORACCI, Berisso (AR); Walter Alberto VARGAS, Berisso (AR); Juan Jose ROMERO, Berisso, Buenos Aires (AR); Brenda BEZUS, Berisso (AR)

(21) Appl. No.: 18/742,707

(22) Filed: Jun. 13, 2024

Related U.S. Application Data
(60) Provisional application No. 63/508,292, filed on Jun. 15, 2023.

(51) Int. Cl. A01N 37/02; A01N 25/04; A01N 35/02; A01N 35/06; A01P 13/02

(52) U.S. Cl. CPC A01N 37/02; A01N 25/04; A01N 35/02; A01N 35/06; A01P 13/02

(57) ABSTRACT

The present description discloses bioherbicide compositions comprising pelargonic acid and an alpha-beta unsaturated carbonylic compound. The active compounds of the bioherbicide composition provide minimal risks for the environment and the human and animal health, while exhibiting excellent herbicidal activity.

### FIELD OF THE INVENTION

The present invention generally relates to the field of agroindustry, particularly to the field of pesticides affecting crops of commercial interest. More specifically, the invention refers to a broad-spectrum bioherbicide useful for pre-emergent and post-emergent action in the control of weeds.

### BACKGROUND OF THE INVENTION

In the current scenario of an ongoing climate change, combined with a degradation of natural resources and environmental contamination, there has been in recent years a trend to move towards productive processes promoting a sustainable development.

Particularly in the field of agroindustry, this trend translates in the emergence of agronomical compositions based on components from biological sources instead of the classical synthetic agrochemicals, taking into account the potential harmful effects the latter could have on the environment.

Pelargonic acid, also known as nonanoic acid, is a compound naturally present in the form of esters in the oil of plants of the genus Pelargonium. It is known to exhibit herbicidal properties, and there are commercially-available bioherbicides based on pelargonic acid.

Cabrera-Perez et al. (2022) showed the efficacy of pelargonic acid in combination with potassium metabisulfite in controlling weeds such as Conyza bonariensis.

U.S. Pat. No. 6,930,075 discloses herbicidal compositions comprising a fatty acid, which is preferably pelargonic acid, and a glyphosate-based herbicidal active ingredient.

Patent application WO 2022/040743 A1 discloses herbicide compositions comprising a fatty acid, particularly nonanoic acid, along with an alcohol alkoxylate, a hydrophobic liquid, a pH sensitive hydrogel forming polymer, and fumed silica. The hydrophobic liquid may be a terpene such as citral, among many others.

Citral is a compound present in the essential oils of several plants. Some of such essential oils have been related to a potential herbicidal activity. For instance, patent application US 2009/0099022 A1 discloses a natural herbicide containing lemongrass essential oil, which comprises citral as one of its main components. Similarly, patent application US 2021/0251218 A1 discloses herbicidal compositions comprising essential oils, among which citronella essential oil (which comprises citral as a major component) may be used.

The herbicidal activity of citral has also been reported by Grana Martinez (2015) and Chaimovitsh et al. (2017).

Additionally, patent application WO 2013/059012 A1 discloses antimicrobial compositions comprising pelargonic acid and aldehydes, among which citral is disclosed.

Thymoquinone is yet another compound present in certain plants with the potential of acting as a bioactive compound in agronomical applications. Herrera et al. (2015) describe an insecticidal activity of thymoquinone. Hasan et al. (2021), on the other hand, provide a review on the status of research on bioherbicides, including a reference to the bioherbicidal activity of quinones obtained from Nigella sativa, as thymoquinone.

Nevertheless, due to the continuing need to provide new and effective bioherbicidal compositions, the present inventors have aimed to develop compositions comprising pelargonic acid combined with other active compounds from natural sources with an improved herbicidal activity.

### SUMMARY OF THE INVENTION

The present invention provides an herbicidal emulsifiable concentrate comprising pelargonic acid, an alpha-beta unsaturated carbonylic compound, and an emulsifier, wherein the pelargonic acid and the alpha-beta unsaturated carbonylic compound are dissolved in the emulsifier.

In an embodiment of the invention, the alpha-beta unsaturated carbonylic compound is selected from the group consisting of citral and thymoquinone.

In an embodiment the pelargonic acid and the alpha-beta unsaturated carbonylic compound are present in the herbicidal emulsifiable concentrate in a combined amount of 20% to 90% v/v. Preferably, the pelargonic acid and the alpha-beta unsaturated carbonylic compound are present in the composition in a combined amount of 25% v/v to 75% v/v.

Most preferably, the pelargonic acid and the alpha-beta unsaturated carbonylic compound are present in the composition in a combined amount of 30% v/v.

In a particular embodiment of the invention, the pelargonic acid and the alpha-beta unsaturated carbonylic compound are present in the herbicidal emulsifiable concentrate in a 1:1 volume ratio.

In another particular embodiment of the invention, the emulsifier is selected from the group consisting of a soy lecithin solution, a sunflower lecithin solution, a mixture of fatty acid methyl esters, a mixture of salmon-derived unsaturated fatty acids, ethoxylated alcohols and mixtures thereof. Preferably, the emulsifier is selected from a soy lecithin solution comprising soy lecithin dissolved in a methylated oil with a silicon-based surfactant, wherein the soy lecithin is in a concentration of 35% w/w, and a combination of a mixture of fatty acid methyl esters and an ethoxylated alcohol.

In a particularly preferred embodiment of the invention, the herbicidal emulsifiable concentrate consists of 15% v/v pelargonic acid and 15% v/v citral dissolved in the emulsifier. More preferably, the emulsifier is selected from a soy lecithin solution comprising soy lecithin dissolved in a methylated oil with a silicon-based surfactant, wherein the soy lecithin is in a concentration of 35% w/w, and a combination of a mixture of fatty acid methyl esters and an ethoxylated alcohol.

In a particularly preferred embodiment of the invention, the herbicidal emulsifiable concentrate consists of 15% v/v pelargonic acid and 15% v/v thymoquinone dissolved in the emulsifier. More preferably, the emulsifier is selected from a soy lecithin solution comprising soy lecithin dissolved in a methylated oil with a silicon-based surfactant, wherein the soy lecithin is in a concentration of 35% w/w, and a combination of a mixture of fatty acid methyl esters and an ethoxylated alcohol. Most preferably, the emulsifier is a soy lecithin solution comprising soy lecithin dissolved in a methylated oil with a silicon-based surfactant, wherein the soy lecithin is in a concentration of 35% w/w.

It is another aspect of this invention to provide an herbicidal composition comprising the herbicidal emulsifiable concentrate of the invention, diluted in water. Preferably, the herbicidal composition comprises the herbicidal emulsifiable concentrate diluted in water in a concentration of 0.1% to 2% v/v.

It is yet another aspect of the invention to provide a method for controlling harmful weeds in a crop, comprising applying the herbicidal composition of the invention to the harmful weeds, or to the soil wherein the harmful weeds are expected to emerge.

In an embodiment of this aspect of the invention, the harmful weeds are selected from the group consisting of Amaranthus hybridus, Lolium spp., Brassicca spp. and Conyza sumatrensis.

In another embodiment of this aspect of the invention, the crop is selected from the group consisting of wheat, soybean and corn.

### BRIEF DESCRIPTION OF THE DRAWINGS

FIG. 1. Results of the post-emergence activity of the emulsifier of the preferred embodiment of the invention. A: A. hybridus, B: B. rapa, C: L. multiflorum, D: L. sativa, E: S. lycopersicum.

FIG. 2. Results of the post-emergence activity of two compositions according to the invention in various plant species.

FIG. 3. Percentage of germination of wheat seeds after the application of formulation 1 (F1) and formulation 2 (F2) at 2 mM (A) and 5 mM (B) at different times (1, 7, and 14 days). For the control, the formulations were replaced with water (H₂O). Vertical bars denote 0.95 confidence intervals. Different letters indicate significant differences (p<0.05).

FIG. 4. Leaf growth of wheat seedlings after the application of formulation 1 (F1) and formulation 2 (F2) at 2 mM (A) and 5 mM (B) at different times (1, 7, and 14 days). For the control, the formulations were replaced with water (H₂O). Vertical bars denote 0.95 confidence intervals. Different letters indicate significant differences (p<0.05).

FIG. 5. Mean±SEM results for maximum quantum yield of photosystem II (Fv/Fm) at 1, 2, 5, 7 and 12 days in 3 assays. Treatments: F1 5 mM (F1); F2 5 mM (F2); water control (H₂O); and atrazine control.

FIG. 6. Mean±SEM (N=6) for the number of C. sumatrensis seedlings developing in sown pots after the application of formulations F3 (A), F4 (B), and F3 (C). Negative control was water, while positive control was atrazine.

FIG. 7. Evolution of P. monteili biomass with different treatments evaluated during 24 hours. C+N represent the active compounds citral and nonanoic acid added directly to the culture medium. Pure water was used as a positive growth control. The results are expressed as mean±SEM (N=3).

### DETAILED DESCRIPTION OF THE INVENTION

The present application discloses a bioherbicide comprising pelargonic acid. The bioherbicide of the invention exhibits an unexpectedly high efficacy, in particular against weeds which are resistant to conventional chemical herbicides, while comprising active ingredients obtained from biological sources, with a minimal risk for the environment and human health. Specifically, the invention provides a liquid herbicidal emulsifiable concentrate comprising pelargonic acid, an alpha-beta unsaturated carbonylic compound, and an emulsifier, wherein the pelargonic acid and the alpha-beta unsaturated carbonylic compound are dissolved in the emulsifier.

“Bioherbicide”, as used throughout the present description, is meant to refer to a compound present in a natural source, specifically in a plant, exhibiting herbicidal activity against weeds. The term is also used for referring to a composition comprising a bioherbicide compound as an active ingredient. Therefore, according to the present description, a “bioherbicide composition” is a composition comprising at least one compound present in a natural source, specifically in a plant, exhibiting herbicidal activity. Since the object of the present invention is to provide compositions comprising bioherbicide compounds, throughout this description, the terms “bioherbicide composition” and “herbicidal composition” are used interchangeably.

The term “herbicidal emulsifiable concentrate” is well-known in the art, and refers to an herbicidal composition comprising at least one herbicidal active ingredient as well as at least one agriculturally acceptable adjuvant, which is intended to be diluted with water (or a similarly suitable carrier) before its application to the target crop. Therefore, by diluting the herbicidal emulsifiable concentrate, the actual herbicidal composition which exerts the intended herbicidal activity on the harmful plants to be controlled is obtained. Preparing an herbicidal emulsifiable concentrate instead of the final herbicidal composition allows for an easier storage and transport of the product, which may then be diluted by the user before its application.

Pelargonic acid, also named nonanoic acid, is a carboxylic acid of 9 carbon atoms with the following chemical structure:

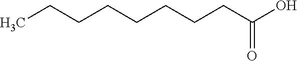

Pelargonic acid is known, and commercially used, as a broad-spectrum post-emergence bioherbicide.

By “alpha-beta unsaturated carbonylic compound”, a person having ordinary skill in the art will understand that the present description refers to a chemical compound comprising a carbonyl (C═O) moiety with at least one carbon-carbon double bond between two carbon atoms located in alpha and beta positions relative to carbonyl moiety. Therefore, the alpha-beta unsaturated carbonylic compound is to be understood as a compound with the following generic structure:

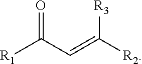

The alpha-beta unsaturated carbonylic compound within the scope of the present invention refers to a compound obtained from natural sources, typically as component of the essential oil of certain plants. Correspondingly, they are liquid, oily compounds. For instance, the alpha-beta unsaturated carbonylic compound may be a pure aldehyde- or keto-terpene, or a component present in at least a 30% v/v in essential oils of plants such as Lippia spp, Nigella spp, Citrus spp or Aloysia spp.

In a preferred embodiment of the invention, the alpha-beta unsaturated carbonylic compound present in the herbicide composition of the invention is selected from the group consisting of citral and thymoquinone.

Citral is an acyclic monoterpene aldehyde found in the essential oils of various plants. Throughout the present description term “citral” is meant to be interpreted as referring to a mixture of two isomers, geranial and neral, as it is commonly used in the art. Geranial and neral have the following chemical structures:

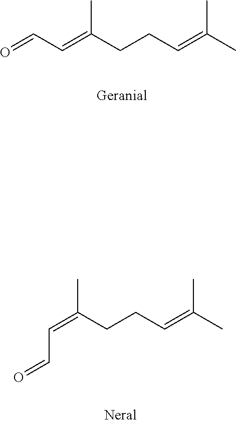

Thymoquinone is a terpene ketone found mainly in the plant Nigella sativa. The chemical structure of thymoquinone is as follows:

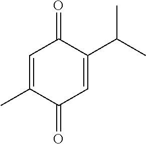

The herbicidal emulsifiable concentrate of the present invention additionally comprises an emulsifier, with the pelargonic acid and the alpha-beta unsaturated carbonylic compound dissolved therein. Since the active ingredients of the composition (i.e., the pelargonic acid and the alpha-beta unsaturated carbonylic compound) have a low water solubility and a comparatively high volatility, the presence of an emulsifier serves to provide an anti-vaporizing and anti-drift effect. As the emulsifier serves as a medium for the active ingredients of the concentrate to be dissolved in, the person of skill in the art will appreciate that the emulsifier must be in a liquid state. This may mean that the emulsifier is either a liquid compound, or a liquid solution of a compound with emulsifying properties. In the latter case, the solvent of the emulsifier serves as a solvent for the active ingredients as well. Such emulsifiers are well known in the art, and a person of skill in the art will readily be able to select a proper emulsifier to include in the herbicidal emulsifiable concentrate of the invention. For instance, the emulsifier may be a soy lecithin solution, a sunflower lecithin solution, a mixture of fatty acid methyl esters, a mixture of salmon-derived unsaturated fatty acids, an ethoxylated alcohol and mixtures thereof.

In a preferred embodiment, the emulsifier is a soy lecithin solution comprising soy lecithin dissolved in a methylated oil with a silicon-based surfactant, wherein the soy lecithin is in a concentration of 35% w/w. This preferred emulsifier provides the additional advantage of causing an inhibition in the germination of some seeds, and in the growth of seedlings, thus potentiating the effect of the active ingredients.

In another preferred embodiment, the emulsifier is a combination of a mixture of fatty acid methyl esters and an ethoxylated alcohol. As appreciated by those of skill in the art, there are several commercially available emulsifiers and/or surfactants based on fatty acid methyl esters, with varied compositions according to the raw materials and reaction conditions used in their preparation. In general, the fatty acid methyl esters which may be included in the emulsifier used in the present invention are obtained from natural sources.

For instance, the emulsifier may comprise a mixture of fatty acid methyl esters obtained from soybean oil, corn oil and/or palm oil, among others. Ethoxylated alcohols, on the other hand, are to be understood throughout this description to encompass those compounds obtained from the reaction of ethylene oxide with a fatty alcohol. The specific compound obtained depends on the fatty alcohol and the reaction conditions, which determines the amount of ethylene oxide molecules added to the fatty alcohol. In general, the ethoxylated alcohols which may be included in the emulsifier used in the present invention are prepared by ethoxylating fatty alcohols obtained from natural sources, typically, plant oils such as coconut oil, corn oil, palm oil, etc.

The pelargonic acid and the alpha-beta unsaturated carbonylic compound are present in the herbicidal emulsifiable concentrate in an amount such that, upon dilution, they maintain a concentration proper for exerting their herbicidal activity. In a preferred embodiment, the pelargonic acid and the alpha-beta unsaturated carbonylic compound are present in the herbicidal emulsifiable concentrate in a combined amount of 20% to 90% v/v. More preferably, the pelargonic acid and the alpha-beta unsaturated carbonylic compound are present in the composition in a combined amount of 25% v/v to 75% v/v. Most preferably, the pelargonic acid and the alpha-beta unsaturated carbonylic compound are present in the composition in a combined amount of 30% v/v.

In a preferred embodiment of the invention, the pelargonic acid and the alpha-beta unsaturated carbonylic compound are present in the herbicidal emulsifiable concentrate in a 1:1 volume ratio. For instance, if the combined concentrations of the pelargonic acid and the alpha-beta unsaturated carbonylic compound are 30% v/v, according to this embodiment of the invention, each active ingredient is present in the herbicidal emulsifiable concentrate in a concentration of 15% v/v.

Correspondingly, in a particularly preferred embodiment of the invention the herbicidal emulsifiable concentrate consists of 15% v/v pelargonic acid and 15% v/v citral dissolved in the emulsifier. More preferably, the emulsifier is selected from a soy lecithin solution comprising soy lecithin dissolved in a methylated oil with a silicon-based surfactant, wherein the soy lecithin is in a concentration of 35% w/w, and a combination of a mixture of fatty acid methyl esters and an ethoxylated alcohol.

In another particularly preferred embodiment of the invention, the herbicidal emulsifiable concentrate consists of 15% v/v pelargonic acid, 15% v/v thymoquinone dissolved in the emulsifier. More preferably, the emulsifier is selected from a soy lecithin solution comprising soy lecithin dissolved in a methylated oil with a silicon-based surfactant, wherein the soy lecithin is in a concentration of 35% w/w, and a combination of a mixture of fatty acid methyl esters and an ethoxylated alcohol.

The present inventors have surprisingly found that the combination of pelargonic acid and the alpha-beta unsaturated carbonylic compound of the invention exhibits a synergistic effect on the herbicidal activity of the compounds.

The herbicidal emulsifiable concentrate of the invention may be prepared by a simple mixture of the components thereof, i.e., by mixing the pelargonic acid, the alpha-beta unsaturated carbonylic compound and the emulsifier, in the corresponding amounts.

As mentioned above, the herbicidal emulsifiable concentrate of the invention is intended to be diluted with water before its application, as it is common practice in the art. Therefore, it is another aspect of the invention to provide an herbicidal composition comprising the herbicidal emulsifiable concentrate of the invention diluted in water. The dilution degree may depend on, for instance, the actual concentration of the active ingredients in the composition, the selected emulsifier, etc. In a preferred embodiment, the herbicidal composition comprises the herbicidal emulsifiable concentrate diluted in water in a concentration of 0.1% to 2% v/v.

The herbicidal composition of the invention exhibits excellent herbicidal activity, both in pre-emergence as in post-emergence application. This is an unexpected effect, as pelargonic acid is known to exhibit a post-emergence herbicidal activity, but no pre-emergence activity had been reported therefor. Accordingly, it is another aspect of the present invention to provide a method for controlling harmful weeds in a crop, comprising applying the herbicidal composition of the invention to the harmful weeds, or to the soil wherein the harmful weeds are expected to emerge. That is, if the composition is to be used as a pre-emergence herbicide, the herbicidal composition should be applied to the soil wherein the harmful weeds are expected to emerge. If the composition is to be used as a post-emergence herbicide, the herbicidal composition should be applied to the harmful weeds themselves. The person of skill in the art will appreciate that the herbicidal composition may be applied in such a manner that it will have both a pre-emergence and a post-emergence herbicidal activity, i.e., both controlling weeds which have already emerged and preventing new weeds from emerging.

The herbicidal composition of the invention is non-selective, and may thus be applied for controlling a variety of harmful weeds. Preferably, the harmful weeds to be controlled by the method of the invention are selected from the group consisting of Amaranthus hybridus, Lolium spp., Brassicca spp. and Conyza sumatrensis.

The dosage of the composition to the crop will depend on several factors, such as the kind of weed to be controlled, the crop being treated, and environmental factors. Generally, though, in an embodiment of the invention, the method comprises applying the herbicidal composition in a dosage of 1 to 2 kg/ha, expressed as the combined weights of both active ingredients per hectare.

It is yet another aspect of the present invention to provide a use of the herbicide end use product of the invention for controlling harmful weeds in a crop. Similar considerations as those for the method described above apply to the aforementioned use as well.

### EXAMPLES

### Example 1—Pre-Emergence Activity of Compositions According to the Invention

Aqueous extracts containing binary mixtures of formulations: F1 (citral+pelargonic acid) and F2 (thymoquinone+pelargonic acid), in both cases with a 1:1 ratio between the active compounds and with the addition of an emulsifier (soy lecithin at 35% w/w, YPF Agro, 2022) at 0.2% v/v, were tested in Petri dishes following the methodology disclosed in U.S. Pat. No. 11,083,197, with some modifications. Briefly, 4 mL of aqueous extracts containing F1 or F2 at 0.07 to 5 mM were tested, wherein the concentrations refer to the combined concentrations of both active ingredients. The extracts were placed onto 9-cm diameter paper disks in Petri dishes. Then, ten seeds of each species were placed onto paper disks. Subsequently, the dishes were closed under the following experimental conditions: room temperature, 26.0±1.8° C.; relative humidity, 50±9.7%; and photoperiod, 12:12. The seeds were considered germinated if their roots were longer than 1 mm. Aqueous extracts without the addition of the bioactive formulation were used as negative control, whereas atrazine was used as positive control. The assays were performed in triplicates for each concentration.

Table 1 shows the Half Maximal Inhibitory Concentration (IC₅₀) for each tested species (Amaranthus hybridus, Brassica rapa, Lolium multiflorum, Lactuca sativa and Solanum lycopersicum), subject to the different concentrations between 0.07 mM and 5 mM (equivalent to 0.00027-0.019 μL/cm²), after 7 days of exposure to each formulation. The IC₅₀ were obtained using the software POLO PLUS (LeOra Software Company).

TABLE 1
Germination IC₅₀ for each tested species, after 7 days of exposure to formulations
F1 and F2. Different letters show significant differences between treatments.

| | IC₅₀ (mM) for each species | | | | |
|---|---|---|---|---|---|
| | (Confidence limit 95%) | | | | |
| Treatment | A. hybridus | B. rapa | L. multiflorum | L. sativa | S. lycopersicum |
| F1 | 0.07(0.03-0.09) a | 1.55 (1.38-1.70) a | 0.24 (0.09-0.319) a | 2.54 (2.21-2.9) a | 1.33 (0.89-1.63) a |
| F2 | 0.07(0.04-0.08) a | 2.32 (1.77-2.90) b | 0.14 (0.08-0.27) a | 4.6 (3.36-10.0) b | 0.99 (0.37-1.38) a |
| Atrazine | 41.03 (25.18-54.16) c | 300 (189.13-368.8) c | 38.99 (25.13-56.11) c | 383.53 (307.12-454.85) c | 37.55 (15.30-49.1) c |

The treatments using F1 and F2 exhibit an inhibition in every tested species. However, the weeds were more susceptible to the formulations than the commercially relevant plants L. sativa and S. lycopersicum. Additionally, it may be observed that F1 was more effective than F2, except for ryegrass (L. multiflorum). Finally, those weeds resistant to glyphosate (A. hybridus and L. multiflorum), were the ones more susceptible to the treatments.

Additionally, both formulations F1 and F2 were more effective than the positive control atrazine 90%, as proven by the fact that atrazine exhibits much higher IC₅₀.

### Example 2—Herbicide Activity of the Emulsifier of the Composition

An aqueous extract comprising the emulsifier used in Example 1 at 0.2% w/w was prepared and seeds of different species were exposed to the extract following a methodology as the one used in Example 1. Pure water was used as a negative control. As shown in Table 2 below, the extract of the emulsifier exhibited a significant inhibitory action in some seeds.

TABLE 2
Germination percentage of different seeds subjected to both treatments,
after 7 days of exposure. The data show the mean ± the standard
deviation for 3 repetitions in different times. Different letters
show significant differences between treatments. T-test (p < 0.05).

| | Germination percentage | | | | |
|---|---|---|---|---|---|
| Treatment | A. hybridus | B. rapa | L. multiflorum | L. sativa | S. lycopersicum |
| H₂0 | 60 ± 17.32 a | 62 ± 16.21 a | 73 ± 12.72 a | 94 ± 7.56 a | 94 ± 9.16 a |
| H₂0 + | 20 ± 7.07 b | 50 ± 15.27 a | 44 ± 8.37 b | 81 ± 11.60 a | 43 ± 20 b |
| Emulsifier | | | | | |

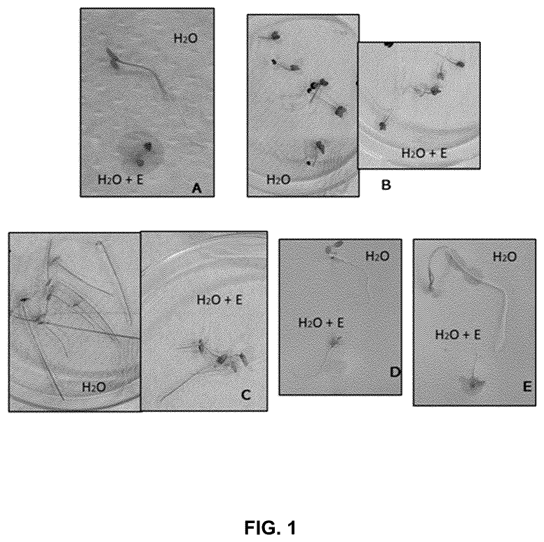

Additionally, seedlings treated with the emulsifier exhibit differences in their length in comparison to those treated with water, as shown in Table 3 below and FIG. 1.

TABLE 3
Seedlings length of different seeds subjected to both treatments, after 7 days of exposure.
The data show the mean ± the standard deviation for 3 repetitions in different times.
Different letters show significant differences between treatments. T-test (p < 0.05).

| | Seedlings length (mm) | | | | |
|---|---|---|---|---|---|
| Treatment | A. hybridus | B. rapa | L. multiflorum | L. sativa | S. lycopersicum |
| H₂0 | 21.42 ± 6.35 a | 91.91 ± 27.69 a | 106 ± 32.11 a | 49.17 ± 13.49 a | 53.7 ± 16.7 a |
| H₂0 + | 7.55 ± 3.53 b | 54.43 ± 26.08 b | 23.33 ± 14.55 b | 29.61 ± 10.48 a | 10.25 ± 6.71 a |
| Emulsifier | | | | | |

### Example 3—Early Post-Emergence Activity of Compositions According to the Invention on Several Plant Species

F1 and F2 were tested at 2 and 5 mM against weeds according to Sosa et al (2021) with modifications. Seeds of the different weeds were pre-incubated in Petri dishes with a filter paper and water for 7 days. After that, seedlings were moved to a new Petri dish containing 4 mL of aqueous extracts containing F1 or F2 and the emulsifier, during 7 days. Water was used as a negative control.

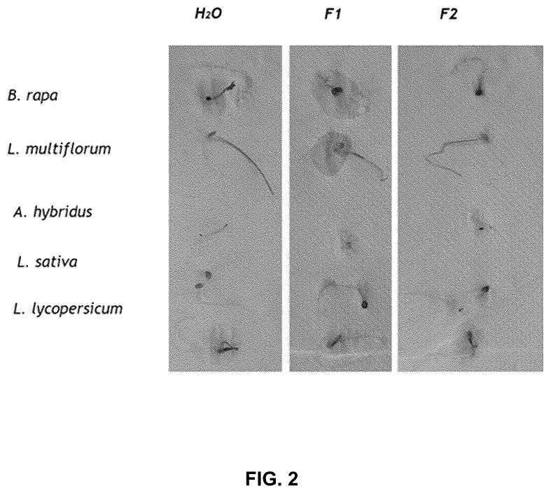

FIG. 2 shows the results after the 7 days exposure. It can be seen that the weeds are weakened manifesting color change.

### Example 4—Early Post-Emergence Activity of Compositions According to the Invention on Wheat

The phytotoxic effect on wheat grains was evaluated according to Peschiutta et al. (2019), with some modifications. Ten grains were placed in Petri dishes after application of the extracts containing F1 or F2 at 2 and 5 mM (equivalent to 0.019 μL/cm²), at different times (1, 7, and 14 days). A negative control was performed with water without the addition of any active compound, and the seeds were placed onto paper disks at the same time intervals. The concentration was selected through the IC₅₀ calculated for B. rapa weed in wheat. Then, the dishes were closed under the same experimental conditions described for Example 1. The number of germinated seeds per dish was counted and the percentage of germination (%) was recorded. The grains were considered germinated if their roots were longer than 1 mm. The leaf length of the wheat seedlings was recorded. The assays were performed in triplicates. Data were analyzed to assess normality using the Shapiro-Wilks test, and homogeneity of the variances was determined using the Levene test before performing ANOVA. ANOVA and Tukey's tests were used for comparing the means for germination and leaf length.

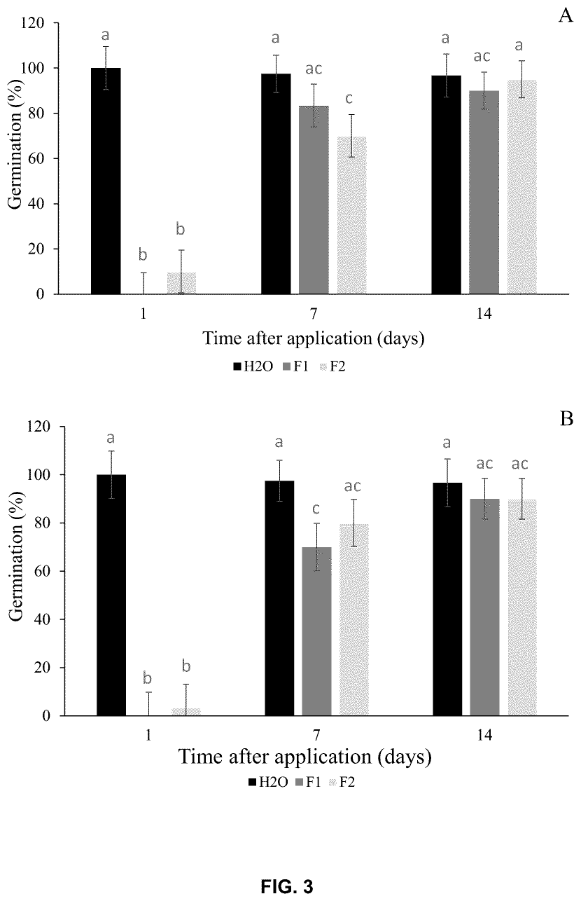

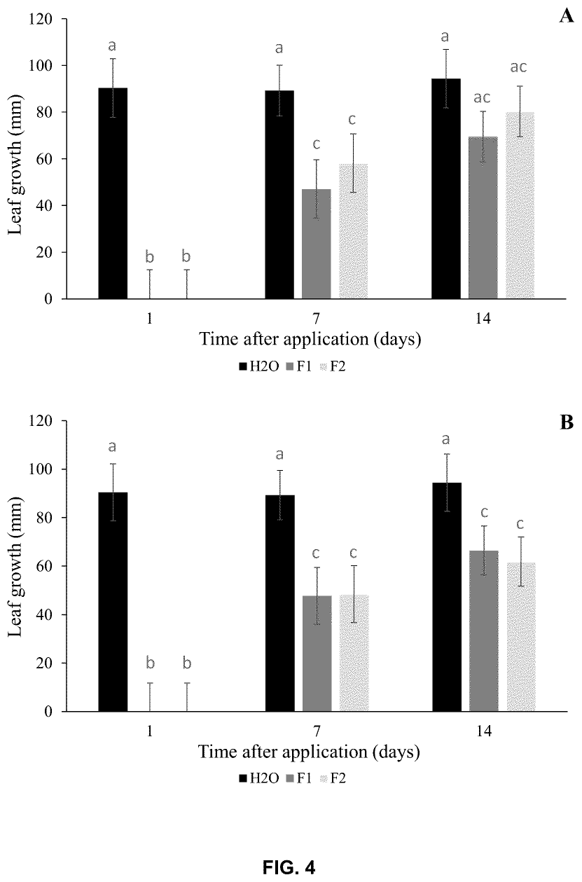

The effect of formulations F1 and F2 on wheat grains is shown in FIGS. 3 and 4. F1 and F2 were toxic at day 1 of application for both concentrations. However, at 7 and 14 days after application no significant differences were observed in the germination percentages for F1 at 2 mM and F1 at 5 mM compared to the control. (FIGS. 3A and B). In contrast, F2 was not phytotoxic at 7 or 14 days after application.

Regarding leaf growth, both F1 and F2 at 5 mM produced growth inhibition at 7 and 14 days after application. Less growth was observed 7 days after application for both formulations at 2 mM, and no significant difference was observed at 14 days after application (FIGS. 4A and B).

This study showed the persistence (i.e., the period in which the herbicide is active in the soil and has phytotoxic capacity) of the formulations over time. It was determined that after 14 days of application, the formulations did not inhibit plant germination or growth.

Therefore, the emulsifier allows for the gradual release of the bioactive compounds because due to its anti-drift action.

### Example 5—Early Post-Emergence Activity and Damage to the Photosynthetic Apparatus of Compositions According to the Invention on Amaranthus hybridus

Plant material and culturing conditions Seeds of Amaranthus hybridus were sown on plastic boxes of 15.5×11×4 cm with moist absorbing paper (25 seeds per box). The boxes were placed in a culture chamber at 22° C. and 50 μmol photons m⁻² s⁻¹ with a photoperiod of 16 hours. The treatments started after 7 days post-sowing, when most of the seedlings exhibited unfolded cotyledons. The application volume for each treatment was 10 ml per box on the absorbing paper. After 7 days post-application, to avoid possible chlorosis symptoms due to a lack of nutrients, 5 ml of nutritive solution were added to each box, with the following formulation: 5.0 mM Ca(NO₃)₂, 5.0 mM KNO₃, 2.0 mM MgSO₄, 1.0 mM KH₂PO₄, 20.0 μM FeNaEDTA, 5.0 μM H₃BO₃, 0.9 μM MnCl₂, 0.8 μM ZnCl₂, 0.3 μM CuSO₄ y 0.01 μM Na₂MoO₄, pH 5.5-6.5. The experiments were finished 12 days post-application.

### Formulations

The tested formulations were F1 and F2, both at 5 mM. The herbicide atrazine at 5 mM was used as a positive control. Distilled water was used as negative control.

### Experiment

The objective was to assess the early post-emergence effect of the tested formulations on seedlings of A. hybridus of 7 days post-sowing. At 1, 2, 5, 7 and 12 days post-application the fluorometry measurements (Fv/Fm) were carried out to ascertain the damage to photosystem II, and the plants with bleaching or chlorosis symptoms were counted. The treatments applied were as follows: F1, F2, water control (C), and atrazine positive control (ATR).

### Quantification of Damage to Photosystem II

The measurements of the maximum quantum yield of photosystem II (Fv/Fm) was carried out with a MINI-PAM II ©Walz fluorimeter. The seedlings were darkened 30 minutes to then obtain the measurements. The measurement of Fv/Fm is used to estimate the damage to the photosynthetic apparatus, specifically to photosystem II. It is considered that a non-senescent mature leaf which does not exhibit damage to photosystem II yields values of Fv/Fm of about 0.8. The maximum values measures for the experiments herein described was of about 0.7, below those expected to a leaf without any damage to photosystem II. However, taking into account that the biologic material of the experiments herein described were small cotyledons of seedlings with few days post-emergence, and that there are antecedents for the Amaranthus genus for values of 0.72 for unstressed leaves, values around 0.7 were considered as indicative of a good state of the photosynthetic apparatus.

### Experimental Design and Statistical Analysis

For the experiments, three boxes per treatment were used: both experiments had 5 treatments. Each experiment was repeated 3 times (assays 1, 2 and 3), and each assay was analyzed separately. The treatments were assigned randomly to each box following a completely randomized design.

The statistical analysis was performed with the software InfoStat with Generalized Mixed Linear Models for analyzing the Fv/Fm data.

### Results

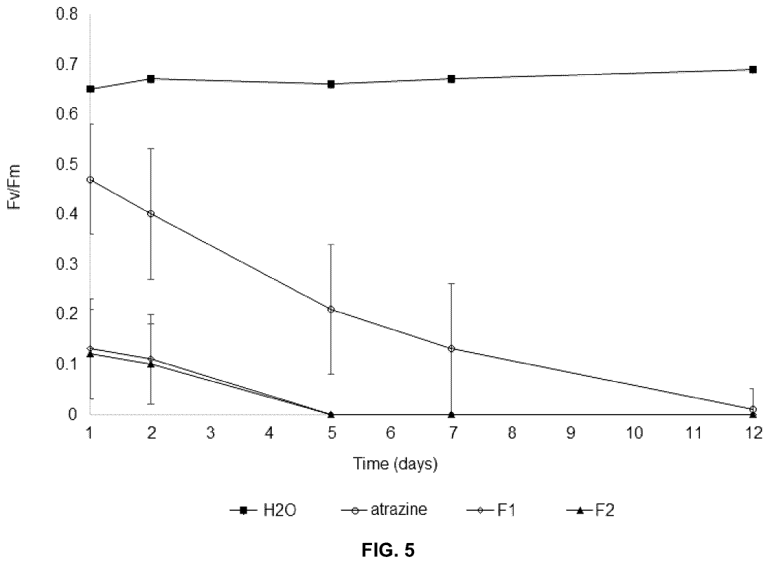

At 24 hours post-application, the seedlings of A. hybridus exhibited significantly lower Fv/Fm values (FIG. 5) for treatments with F1 and F2 in comparison with negative control C, and the positive control ATR.

At 48 hours, the Fv/Fm values were kept low and significantly lower with respect to those of the positive and negative controls, with a trend to decrease with respect to day 1 (FIG. 5). The Fv/Fm measurements could only be carried out until 48 h, since the severe damage to photosystem II exerted by the formulations did not allow for any further measurements at 5, 7 and 12 days post-application.

Treatment ATR (positive control) had a gradual fall in the Fv/Fm values from day 1 until reaching minimum or non-measurable values at 12 days. In every assay ATR exhibited lower effects on photosystem II in comparison to treatments F1 and F2.

Water controls (C) exhibited no damage to the photosystem in any of the assays.

### Example 6—Preparation of Emulsifiable Concentrates Based on Methyl Esters

With the purpose of studying the compatibility of the bioactive agents of the invention with latest-generation emulsifiers based on methyl esters used in the agricultural industry, emulsifiable concentrates based on F1 as described in Example 1 were prepared, with citral and pelargonic acid dissolved in the emulsifier in a 1:1 volume ratio, with a combined concentration of 30% v/v. The emulsifiers used were Bioboll®, provided by Methil Group S.R.L., and Sonic® and Chalten®, both provided by Nova S.A. Table 4 shows the components of three formulations (F3, F4 and F5) thus obtained. It should be noted that F4 and F5 exhibit the capacity of forming microemulsions.

TABLE 4
Compositions based on methyl ester emulsifiers. The concentrations
refer to the compounds in each corresponding emulsifier product,
which also comprise inert ingredients to reach 100% volume.

| Ingredients | F3 | F4 | F5 |
|---|---|---|---|
| Citral (C) | ✓ | ✓ | ✓ |
| Nonanoic acid (N) | ✓ | ✓ | ✓ |
| Bioboll ® (methyl esters (78% v/v) + | ✓ | — | — |
| reverse emulsifiers) | | | |
| Sonic ® (methyl esters (74% v/v) + | — | ✓ | — |
| ethoxylated alcohol (1.5% v/v)) | | | |
| Chaltén ® (methyl esters (68% v/v) + | — | — | ✓ |
| ethoxylated alcohol (10.5% v/v)) | | | |

All three compositions were tested for emulsion stability, which was evaluated at different times (0, 0.5, 2, 24 and 24.5 h) at 30±2° C., according to standard MT 36.3. On the other hand, accelerated aging tests were performed at 50±2° C. for 4 weeks. All three compositions resulted stable, and the accelerated aging tests allowed to establish that they may be stored for 2 years.

### Example 7—Effect of the Compositions Based on Methyl Esters on the Weed Conyza sumatrensis

The compositions prepared in Example 6 were tested in greenhouse against the agronomically relevant weed Conyza sumatrensis, which is considered difficult to handle.

The assay was carried out in a greenhouse under non-controlled conditions in pots (11×11×12 cm) with a ratio of 80% Ramallo series soil and 20% sand. The pots were sown with 100 weed seeds, with a germinative power of 20%, to be evaluated per pot, in non-controlled conditions. Then, 5 treatments as detailed in Table 5 were applied. The negative control was water, while the positive control was atrazine 90%. 6 repetitions per treatment were carried out. The applications were performed with an experimental backpack with CO₂, and a 20 mm rain was simulated to incorporate the herbicides and to generate the germination of the weed.

TABLE 5
Treatments applied to pots of Conyza sumatrensis

| Treatment | Dose (g/Ha) | Active ingredients (g) |
|---|---|---|
| F3 | 3000; 1500; 833 | 900; 450; 225 |
| F4 | 3000; 1500; 833 | 900; 450; 225 |
| F5 | 3000; 1500; 833 | 900; 450; 225 |
| Atrazine | 1000; 500; 250 | 900; 450; 225 |
| Negative control | N/A | 0 |

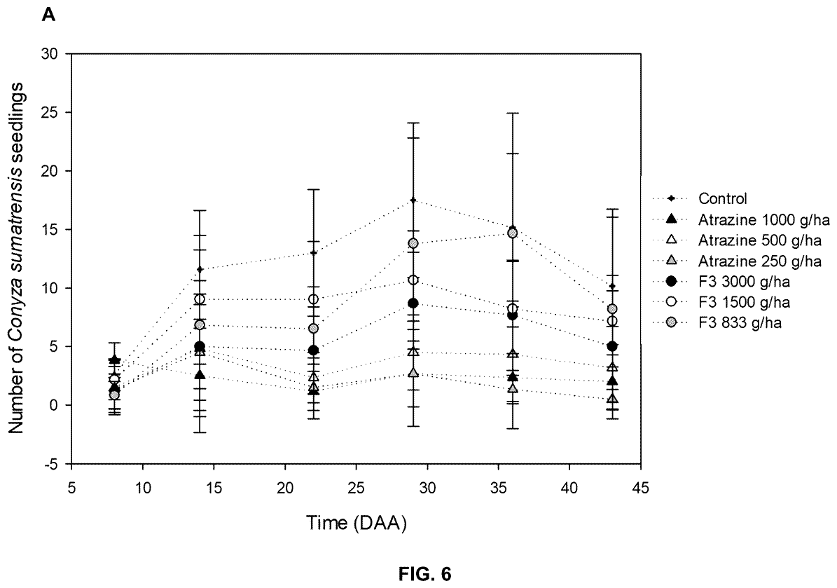

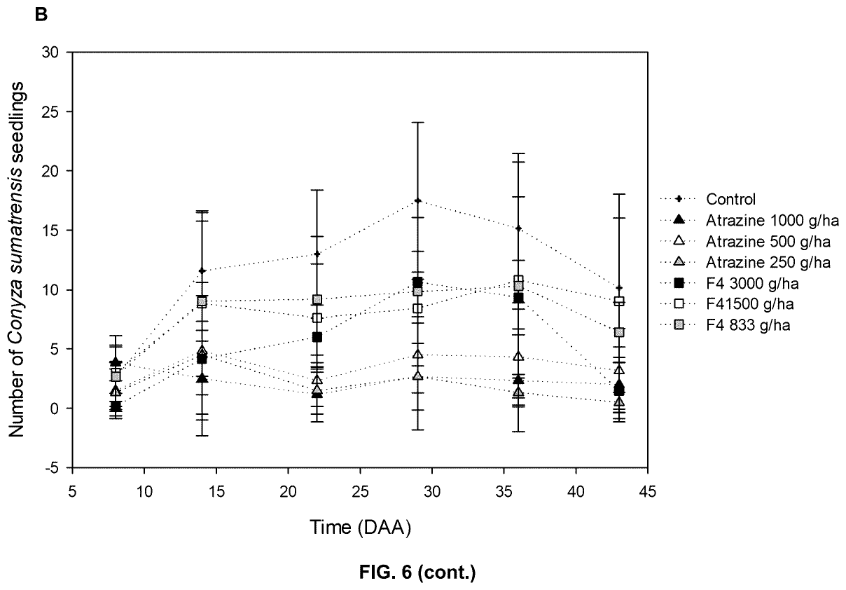

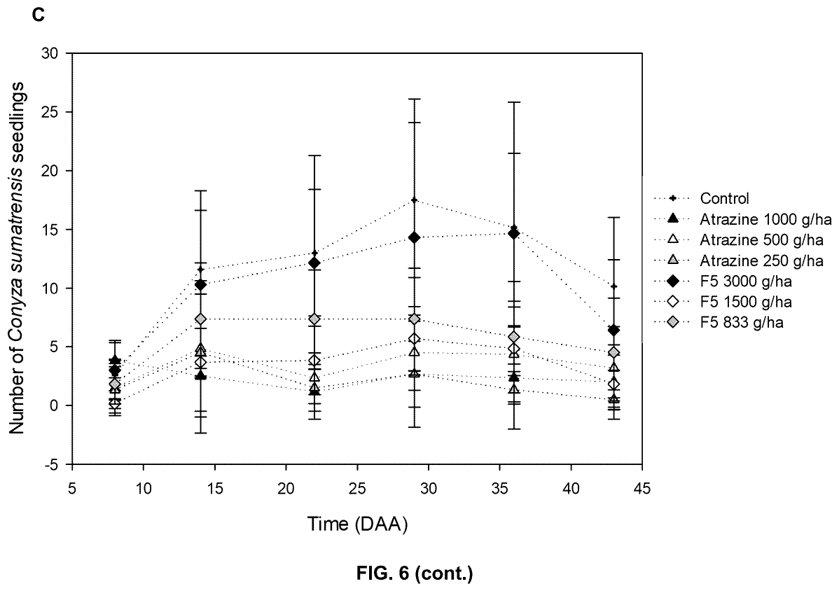

It was observed that the compositions of the invention cause a decrease in the number of C. sumatrensis seedlings in comparison to the negative control (FIG. 6). Particularly, F5 at 1500 y 833 g/Ha, equivalent to 450 y 225 g of active ingredients, had a significant effect in the decrease of the number of C. sumatrensis seedlings, roughly equal to the action of the positive control atrazine at the same doses. On the other hand, F3 at 900 g of active ingredients (3000 g/Ha) has a significant effect on the number of seedlings.

### Example 8—Effect of Compositions Based on Methyl Esters on Growth-Promoting Bacteria Present in Soil Microbiota

To evaluate the effect of the compositions prepared in Example 6 on growth-promoting bacteria, a model strain of Pseudomonas monteilii was used. The microorganism was inoculated in liquid LB medium (initial optical density at 600 nm=0.1), and incubated in Erlenmeyer flasks at 32° C., 180 rpm. The effect of the active compounds (citral (C)+pelargonic acid (N), at a combined concentration of 5 mM), F3, F4 and F5 (all three at 0.5% v/v) and atrazine (5 mM) was assessed by adding each treatment to the culture medium at the moment of inoculation. The positive growth control was performed without adding any compound. Liquid samples were taken during the growth, and the biomass of the cultures was evaluated using the drop plate method described by Herigstad et al. (2001). Three repetitions were carried out in different times and the results were analyzed with the software Statistica (StatSoft, 2007) to adjust them to the Gompertz model, and thus calculate the growth parameters.

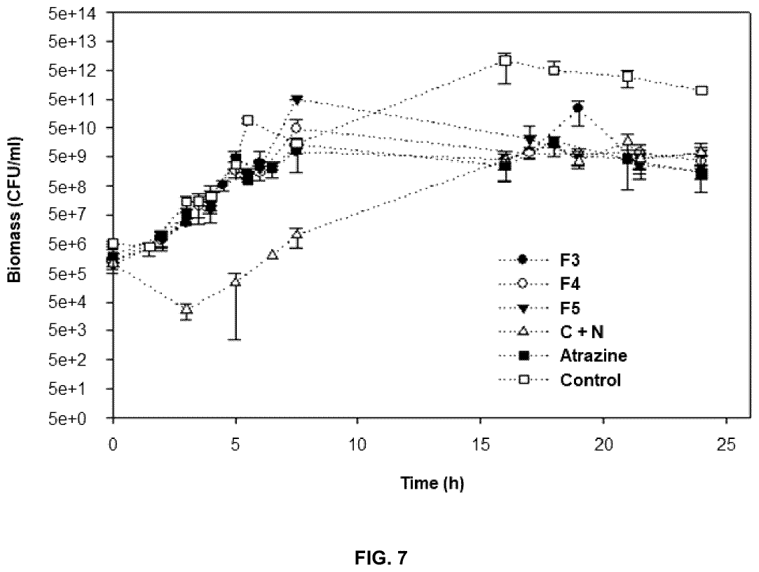

FIG. 7 shows the evolution of P. monteiliibiomass in the different treatments evaluated during 24 hours. Table 6 shows the growth parameters of the microorganism in the different cultures.

TABLE 6
Growth parameters of planktonic cells of P. monteilii: maximum
growth rate (μₘₐₓ), length of the lag phase and duplication
time, according to the adjustment to Gompertz model

| | | Lag pase | Duplication | |
|---|---|---|---|---|
| Treatment | μₘₐₓ (h⁻¹) | length (h) | time (min) | r² |
| C + N | 1.95 | 6.7 | 21.28 | 0.925 |
| F3 | 2.12 | 1.5 | 19.61 | 0.970 |
| F4 | 2.15 | 1.5 | 19.29 | 0.965 |
| F5 | 2.13 | 1.1 | 19.54 | 0.971 |
| Atrazine | 1.89 | 1.3 | 22.03 | 0.930 |
| Control | 1.71 | 1.3 | 24.29 | 0.960 |

It was observed that, at the end of the cultures, all treatments had in average 3 log less biomass than the control. However, growth rate of the microorganism was not lower in any of the treatments in comparison to the control, as appreciated in the μₘₐₓ values obtained for the different cultures.

As a conclusion, the compositions produced a decrease in the biomass of the microorganisms (cellular yield), buy did not affect negatively their growth rate.

### REFERENCES

1—Chaimovitsh, D., Shachter, A., Abu-Abied, M., Rubin, B., Sadot, E., & Dudai, N. (2017). Herbicidal activity of monoterpenes is associated with disruption of microtubule functionality and membrane integrity. Weed Science, 65(1), 19-30.
2—Cabrera-αérez et al. Herbicidal Effect of Different Alternative Compounds to Control Conyza bonariensis in Vineyards. Agronomy 2022, 12, 960.
3—Grana Martinez, E. (2015). Mode of action and herbicide potential of the therpenoids farnesene and citral on Arabidopsis thaliana metabolism (Doctoral dissertation, Bioloxfa vexetal e ciencias do solo).
4—Hasan, M.; Ahmad-Hamdani, M. S.; Rosli, A. M.; Hamdan, H. Bioherbicides: An Eco-Friendly Tool for Sustainable Weed Management. Plants 2021, 10, 1212.
5—Herigstad, B., Hamilton, M., Heersink, J., 2001. How to optimize the drop plate method for enumerating bacteria. Journal of Microbiological Methods, 44(2), 121-129.
6—Herrera, J. M., Zunino, M. P., Dambolena, J. S., Pizzolitto, R. P., Ganan, N. A., Lucini, E. I., & Zygadlo, J. A. (2015). Terpene ketones as natural insecticides against Sitophilus zeamais. Industrial Crops and Products, 70, 435-442.
7—Peschiutta, M. L., Brito, V. D., Achimon, F., Zunino, M. P., Usseglio, V. L., & Zygadlo, J. (2019). New insecticide delivery method for the control of Sitophilus zeamais in stored maize. Journal of Stored Products Research, 83:185-190.
8—Sosa, G., & Belgrano, M. J. (2021). Desarrollo de nuevas formulaciones para incrementar Ia eficiencia y el uso racional de agroquimicos. Anuario de Investigación USAL, 7, Article 7.

1. An herbicidal emulsifiable concentrate comprising pelargonic acid, an alpha-beta unsaturated carbonylic compound, and an emulsifier, wherein the pelargonic acid and the alpha-beta unsaturated carbonylic compound are dissolved in the emulsifier.

2. The herbicidal emulsifiable concentrate of claim 1, wherein the alpha-beta unsaturated carbonylic compound is selected from the group consisting of citral and thymoquinone.

3. The herbicidal emulsifiable concentrate of claim 1, wherein the pelargonic acid and the alpha-beta unsaturated carbonylic compound are present in the herbicidal emulsifiable concentrate in a combined amount of 20% to 90% v/v.

4. The herbicidal emulsifiable concentrate of claim 3, wherein the pelargonic acid and the alpha-beta unsaturated carbonylic compound are present in the composition in a combined amount of 25% to 75% v/v.

5. The herbicidal emulsifiable concentrate of claim 4, wherein the pelargonic acid and the alpha-beta unsaturated carbonylic compound are present in the composition in a combined amount of 30% v/v.

6. The herbicidal emulsifiable concentrate of claim 1, wherein the pelargonic acid and the alpha-beta unsaturated carbonylic compound are present in the herbicidal emulsifiable concentrate in a 1:1 volume ratio.

7. The herbicidal emulsifiable concentrate of claim 1, wherein the emulsifier is selected from the group consisting of a soy lecithin solution, a sunflower lecithin solution, a mixture of fatty acid methyl esters, a mixture of salmon-derived unsaturated fatty acids, an ethoxylated alcohol, and mixtures thereof.

8. The herbicidal emulsifiable concentrate of claim 7, wherein the emulsifier is a soy lecithin solution comprising soy lecithin dissolved in a methylated oil with a silicon-based surfactant, wherein the soy lecithin is in a concentration of 35% w/w.

9. The herbicidal emulsifiable concentrate of claim 7, wherein the emulsifier is a combination of a mixture of fatty acid methyl esters and an ethoxylated alcohol.

10. The herbicidal emulsifiable concentrate of claim 1, wherein the herbicidal emulsifiable concentrate consists of 15% v/v pelargonic acid and 15% v/v citral dissolved in the emulsifier, wherein the emulsifier is a soy lecithin solution comprising soy lecithin dissolved at a concentration of 35% w/w in a methylated oil with a silicon-based surfactant.

11. The herbicidal emulsifiable concentrate of claim 1, wherein the herbicidal emulsifiable concentrate consists of 15% v/v pelargonic acid and 15% v/v citral dissolved in the emulsifier, wherein the emulsifier is a combination of a mixture of fatty acid methyl esters and an ethoxylated alcohol.

12. The herbicidal emulsifiable concentrate of claim 1, wherein the herbicidal emulsifiable concentrate consists of 15% v/v pelargonic acid and 15% v/v thymoquinone dissolved in the emulsifier, wherein the emulsifier is a soy lecithin solution comprising soy lecithin dissolved at a concentration of 35% w/w in a methylated oil with a silicon-based surfactant.

13. The herbicidal emulsifiable concentrate of claim 1, wherein the herbicidal emulsifiable concentrate consists of 15% v/v pelargonic acid and 15% v/v thymoquinone dissolved in the emulsifier, wherein the emulsifier is a combination of a mixture of fatty acid methyl esters and an ethoxylated alcohol.

14. An herbicidal composition comprising the herbicidal emulsifiable concentrate of claim 1, diluted in water.

15. The herbicidal composition of claim 14, comprising the herbicidal emulsifiable concentrate diluted in water in a concentration of 0.1% to 2% v/v.

16. A method for controlling harmful weeds in a crop, comprising applying the herbicidal composition of claim 14 to the harmful weeds, or to the soil wherein the harmful weeds are expected to emerge.

17. The method of claim 16, wherein the harmful weeds are selected from the group consisting of Amaranthus hybridus, Lolium spp., Brassicca spp. and Conyza sumatrensis.

18. The method of claim 16, wherein the crop is selected from the group consisting of wheat, soybean and corn.
